(19) United States
(12) Patent Application Publication
(10) Pub. No.: US 2024/0160735 A1
(43) Pub. Date: May 16, 2024

(54) Malware Detection and Registry Repair Scripting

(71) Applicant: PC Matic Inc, SIOUX CITY, IA (US)

(72) Inventors: Matthew Quincy Riley, Owosso, MI (US); Robert J. Cheng, Myrtle Beach, SC (US); Andrew G. Tuch, Boca Raton, FL (US)

(73) Assignee: PC Matic Inc, SIOUX CITY, IA (US)

(21) Appl. No.: 18/055,891

(22) Filed: Nov. 16, 2022

(51) Int. Cl. G06F 21/56

(52) U.S. Cl. CPC G06F 21/56; G06F 2221/034

(57) ABSTRACT

A system and method for computer security of a protected device includes monitoring software running on a protected device that periodically scans the protected device looking for changes to startup items that are suspicious. Upon finding such items, the monitoring software removes the suspicious item and/or sends details of the item to a server. At the server, a researcher reviews the details to determine if the changes are malicious and what steps must be taken to back-out the malicious changes such as deleting malicious executables and scripts that were installed, restoring backup files, removing add-ons that were installed in browsers, etc. The researchers then create a script that will run on the affected device to implement the steps required to repair the infected device then the researcher remotely accesses the affected device, installs the script and runs the script on the protected device to remove the malicious software.

### FIELD OF THE INVENTION

This invention relates to the field of computer security and more particularly to a system for monitoring and preventing malware from adding a malicious program to run at system startup and repairing the same.

### BACKGROUND OF THE INVENTION

For many operating systems, facilities are provided to automatically run programs at startup. One such mechanism in one popular operating system is by adding an entry to the registry containing a link to the program (e.g., the path to a folder in which the program is stored and the name of the program).

Hackers have used these mechanisms to infect devices with malware. In such, the user of the device unknowingly executes a program that includes malware. If the program is allowed to execute, the program installs an executable somewhere in the filesystem and modifies the list of programs that are run at system start (e.g., the registry) to run that executable at system initiation. The user sees no difference in operation of their device as it only takes seconds for the malware to perform these tasks, therefore, the user does not suspect that they have infected their device. Now, the next time the device is rebooted, the program runs as a startup program, often before other startup programs like virus protection programs begin to run or completely initialize, so this malicious program is often not detected by the virus protection programs, even if the malicious program is within a blacklist. Once running, the malicious program is able to make other modifications to the device, copy files, install other malicious programs, etc.

A recent example of this occurred with a malicious windowsupdate.vbs file. This script appeared to be a normal periodic windows update, but instead, it added a program to the “run at start” registry entries and also put files into the run folder, which is a folder of programs that run at system start. After the malicious software was detected on many devices, researchers developed scripts to remove the malicious programs and delete the registry entries that were added/modified.

Some such malicious software is known as “infinite alert.” In this, the malware installs a program and adds an entry into the startup list (e.g., adds an entry to the registry or start folder) to initiate that program when the computer is rebooted. The malware also adds an “add-on” into the device's Internet browser. The add-on that is added to the internet browser displays a full-screen message telling the user that they have a virus and must call a phone number to fix the problem. If the user reboots the device, the malicious program again runs at startup and displays the same error message, making it difficult for a novice user to get rid of the message.

What is needed is a system that will detect unauthorized run-at-startup programs.

### SUMMARY OF THE INVENTION

Elements of the disclosed invention include monitoring software running on a protected device (e.g., computer) that periodically scans the registry and/or startup folders looking for changes that are possibly malicious, especially if a program is added to run at system startup. Upon finding such changes, the monitoring software sends details of what was found to a server. At the server, a researcher reviews the details to determine if the changes are malicious and what steps must be taken to back-out the malicious changes such as deleting malicious executables and scripts that were installed, restoring backup files (e.g., registries), removing add-ons that were installed in browsers, etc. The researchers then create a script that will run on the affected device to implement the steps required to repair the infected device then the researcher remotely accesses the affected device, installs the script and runs the script on the protected device to remove the malicious software.

In one embodiment, a system for device security is disclosed. The system protects a protected device that has a processor and an operating system software running on the processor. Security software running on the protected device has local data for control of the security software. The security software periodically accesses a list of start-up items (e.g., from the operating system) and for each start-up item in the list of start-up items, the security software determines when that start-up item is malware and when that start-up item is malware, the security software initiates actions to disable that start-up item.

In another embodiment, a method of protecting a protected device is disclosed. The protected device that has a processor and an operating system running on the processor. The method includes periodically retrieving a list of start-up items from the operating system and for each start-up item in the list of start-up items, determining when each start-up item is malware using local data and when each start-up item is malware, taking action(s) to disable that start-up item.

In another embodiment, a system for device security is disclosed. The system runs on a protected device that has a processor and an operating system executed by the processor. The system includes computer security system software stored in non-transitory storage of the protected device. The computer security system software has local data and the security system software is executed by the processor to periodically access a list of start-up items from the operating system and for each start-up item in the list of start-up items, the security software determines when that start-up item is malware using the local data and when that start-up item is malware, the security software initiates actions to disable that start-up item

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the system for monitoring and repairing startup programs on a protected device.

FIG. 2 illustrates a schematic view of a typical protected device, protected by the system for monitoring and repairing startup programs.

FIG. 3 illustrates a schematic view of a typical server computer system.

FIGS. 4 and 5 illustrate exemplary program flows of the system for monitoring and repairing startup programs on a protected device.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

In general, the system for monitoring and repairing startup programs monitors operating system facilities that provide for execution of programs each time the protected device is started (e.g., booted).

Throughout this description, the term, “protected device” refers to any device that has a processor, runs software and is protected by the system for monitoring and repairing startup programs. One example of such is a personal computer. Another example is a smartphone or tablet. The term, “user” refers to a human that has an interest in the target device, perhaps a user who is using the target device.

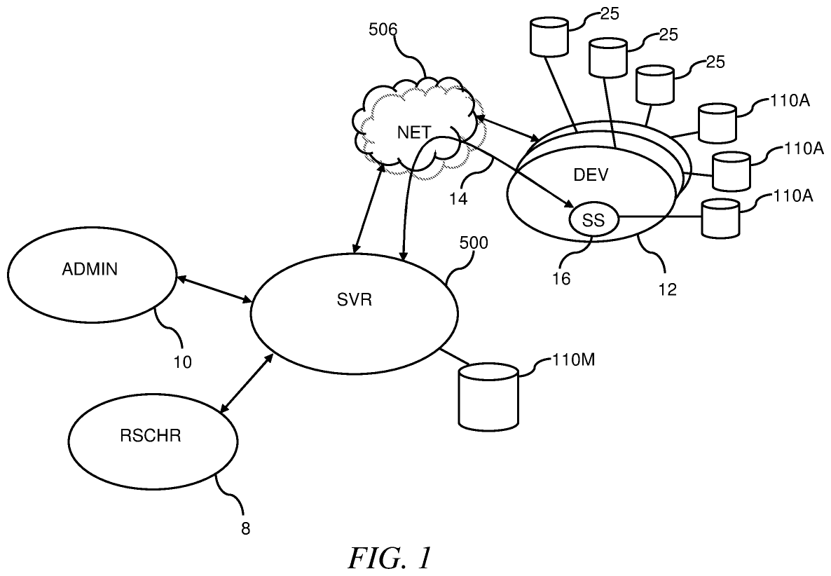

Referring to FIG. 1 illustrates a data connection diagram of the exemplary system for monitoring and repairing startup programs. In this example, a master file 110M is stored in a storage of a server 500 and manipulated by an administrator device 10, by an administrator. As an example, the master file 110M includes a master list of approved programs that are permitted to be run at startup of the target device 12, as for example, a whitelist of approved programs. The administrator edits/manages the master file 110M and, once ready, transfers the master file 110M to the target devices 12 where the list of approved programs is stored locally as local data 110A (e.g., in memory, a file). The security software 16 running on the protected device 12 periodically retrieves a list of start-up items 25 (e.g., from the operating system running on the protected device 12), for example, every ten minutes. The security software 16 checks each item in the list of start-up items 25 using the local data 110A to determine if that start-up item 25 (e.g., program, script) is an approved start-up item (e.g., the start-up item 25 is in a whitelist of the local data 110A) or if the start-up item 25 is a banned start-up item (e.g., the start-up item 25 is in a blacklist of the local data 110A).

If the start-up item 25 is not approved or is banned, the security software 16 disables, quarantines, or deletes the start-up item 25 as best as possible, or if the start-up item is known malware and there is a script for repairing such, the security software 16 runs the script to remove the start-up item 25. In some embodiments, the security software sends a transaction to the server 500 that includes data that describes details of the start-up item 25 such as a copy of the potentially malicious program or script, registry changes that were made to run the start-up item 25 at startup, browser add-ons and any other changes detectable on the protected device 12 around the time that the start-up item 25 appeared on the protected device. In some embodiments, the security software 16 also notifies a user of the protected device 12, for example by a message (e.g., SMS or email) or a pop-up message.

When the transaction containing the details of the start-up item 25 is received by the server 500, software running on the server 500 performs an analysis of the start-up item 25 to determine if the item has already been identified and if there is a repair-up script for the start-up item 25. If so, software running on the server remotely accesses the protected device 12 and runs the repair-up script to remove the start-up item 25.

If the analysis determines that the item is new, a researcher analyzes the start-up item 25 to determine if the item is malicious and, if malicious, to create the repair script. Once the repair script is created, the researcher remotely accesses the protected device 12 and runs the repair script to remove the start-up item 25 and make sure all elements of the start-up item 25 are removed/stopped.

If the researcher determines that the start-up item 25 is not malicious, the start-up item 25 is added to a whitelist of the master file 110M which is or will be distributed to the protected devices 12 and the start-up item 25 will be allowed on the protected devices 12.

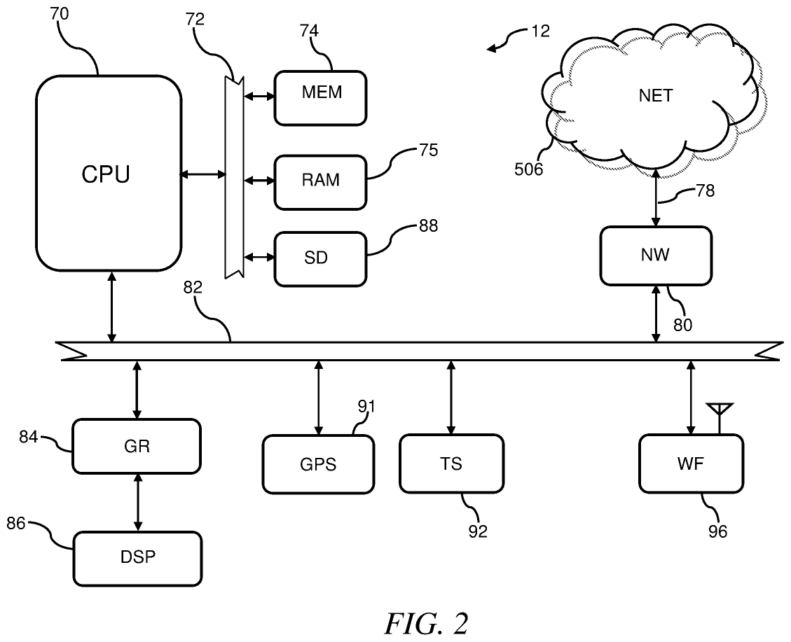

Referring to FIG. 2, a schematic view of an exemplary protected device 12 is shown. The exemplary protected device 12 is a processor-based device that is protected from malware by security software 16 (see FIG. 1). The present invention is in no way limited to any particular protected device 12, as many other processor-based devices are equally anticipated including, but not limited to smart phones, cellular phones, portable digital assistants, routers, thermostats, fitness devices, etc.

The exemplary protected device 12 represents a typical device used by an end user or employee. This exemplary protected device 12 is shown in its simplest form. Different architectures are known that accomplish similar results in a similar fashion, and the present invention is not limited in any way to any particular system architecture or implementation. In this exemplary protected device 12, a processor 70 executes or runs programs in a random-access memory 75. The programs are generally stored within a persistent memory 74 and loaded into the random-access memory 75 when needed. In some protected devices 12, a removable storage slot 88 (e.g., compact flash, SD) offers removable persistent storage. The processor 70 is any processor, typically a processor designed for phones. The persistent memory 74 and random-access memory 75 are connected to the processor by, for example, a memory bus 72. The random-access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some exemplary protected devices 12, the persistent memory 74 is removable, in the form of a memory card of appropriate format such as SD (secure digital) cards, micro-SD cards, compact flash, etc. In some exemplary protected devices 12, the persistent memory 74 is a disk drive (not shown for brevity and clarity reasons) connected to the system bus 82.

Also connected to the processor 70 is a system bus 82 for connecting to peripheral subsystems such as a network interface 80, a graphics adapter 84 and a touch screen interface 92. The graphics adapter 84 receives commands from the processor 70 and controls what is depicted on the display 86. The touch screen interface 92 provides navigation and selection features.

In general, some portion of the persistent memory 74 and/or the removable storage 88 is used to store programs, executable code, phone numbers, contacts, and data, etc. In some embodiments, other data is stored in the persistent memory 74 such as audio files, video files, text messages, etc.

The peripherals are examples, and other devices are known in the industry such as Global Positioning Subsystems, speakers, microphones, USB interfaces, cameras, microphones, Bluetooth transceivers, Wi-Fi transceivers 96, touch screen interfaces 92, image sensors, temperature sensors, etc., the details of which are not shown for brevity and clarity reasons.

The network interface 80 connects the exemplary protected device 12 to the network 506 (e.g., the Internet, LAN, WAN) through any known or future protocol such as Ethernet, WI-FI, GSM, TDMA, LTE, etc., through a wired and/or wireless medium. There is no limitation on the type of connection used. The network interface 80 provides data and messaging connections between the exemplary protected device 12 and the server 500 through the network 506.

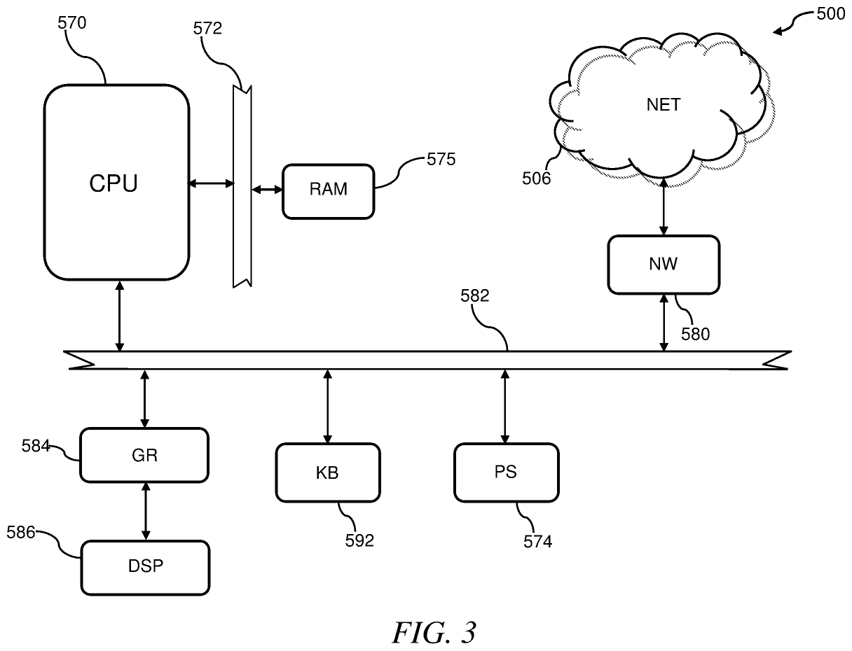

Referring to FIG. 3, a schematic view of a typical server 500 is shown. The exemplary server 500 represents a typical server computer system. Although the exemplary server 500 is shown as a stand-alone system, it is fully anticipated that the server 500 be part of a cloud-computing environment or include multiple computers. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a network 506—e.g., the Internet, WAN, LAN), a graphics adapter 584 and a keyboard interface 592 (e.g., Universal Serial Bus—USB). The graphics adapter 584 receives information from the processor 570 and controls what is depicted on a display 586. The keyboard interface 592 provides navigation, data entry, and selection features.

In general, some portion of the persistent memory 574 is used to store programs, executable code, master files 110M, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

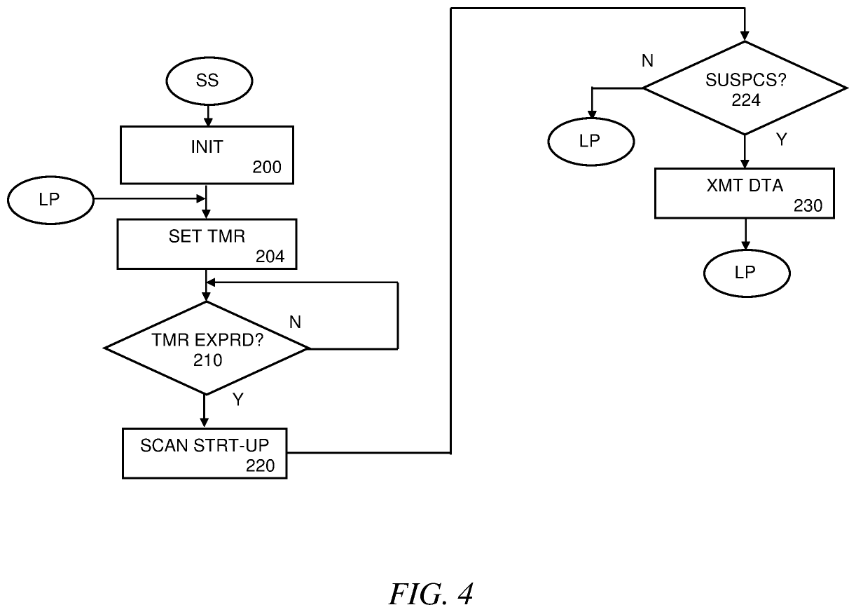

Referring to FIG. 4, a process flow for the security software 16 that runs on the protected device 12 is shown. Note that in most embodiments of the security software 16, the security software 16 also performs other security-related functions.

In the example of FIG. 4, the security software 16 running on the protected device 12 initializes 200 then periodically sets a timer 204, for example, setting a timer 204 for ten minutes. When the timer expires 210, the security software 16 performs a scan 220, looking at all start-up items 25 that the operating system will run during startup (for example, in MS Windows®, startup entries are stored in the registry or in a special startup folder). The security software 16 determines if any of the start-up item 25 are suspicious 224. The security software 16 determines if any of the start-up item 25 are suspicious 224, for example, by comparing the start-up item 25 to the previous set of start-up item 25 and any new start-up item 25 are declared suspicious or checking to see if all of the start-up items 25 are in a known to be valid (e.g., a whitelist of the local data 110A) or if the start-up item 25 are banned (e.g., the start-up item 25 is in a blacklist of the local data 110A). For example, if the start-up item 25 (e.g., a program or script) is in a blacklist, when the security software 16 is operational, the security software 16 will prevent the item from running. During system boot, it is possible that the start-up item 25 will initialize and run before the security software 16 initializes and, therefore, will not be blocked.

For each start-up item 25 that the analysis determines is suspicious, a data record is transmitted 230 to the server 500. This data record includes data regarding the start-up item 25 including any or all of the item, a copy of the startup entry, a copy of the entire registry, any auxiliary file that was created when the start-up item 25 was installed, etc.

The above is an exemplary implementation using a time delay and it is equally anticipated to implement the same or similar functionality using interrupt algorithms or any way to periodically check for suspicious startup items.

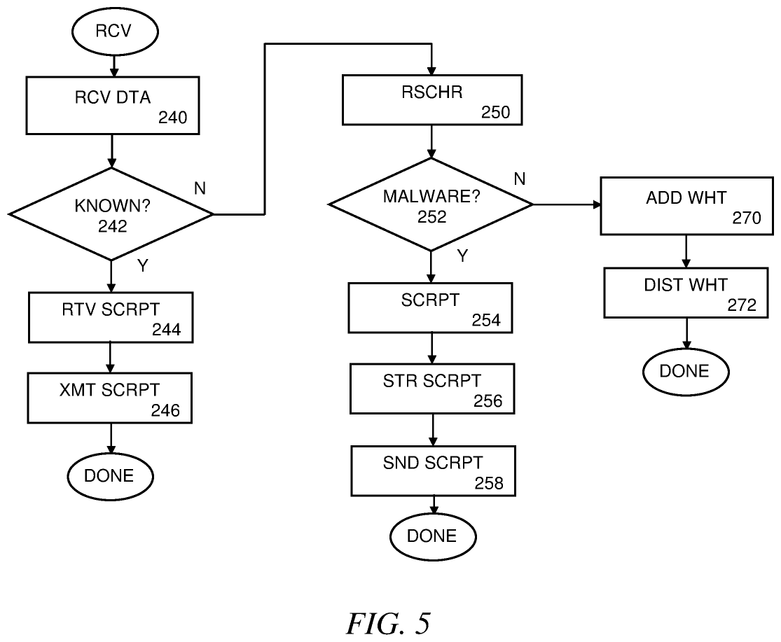

Referring to FIG. 5, a process flow for the server software that runs on the server 500 is shown. Note that in most embodiments of the server software, the server software also performs other security-related functions.

In FIG. 5, the software running on the server 500 receives 240 the data record from the security software 16 running on a protected device 12. The software running on the server 500 analyzes the data record and determines if the start-up item 25 is already known 242 (e.g., the start-up item 25 has already been analyzed by a researcher and a repair script has been created). If the start-up item 25 is known malware 242, a repair script is retrieved 244 and either transmitted 246 to the protected device 12 or a remote access is made to the protected device 12 and the repair script is used to repair the protected device 12. As an example, if it is known that a certain process is running with this type of start-up item 25 (e.g., a known malware), the process is killed; if certain programs or scripts are included with this start-up item 25, those programs or scripts are quarantined or deleted; if a registry entry is made to initialize the start-up item 25 at startup, the registry is cleaned, etc.

If the start-up item 25 is not already known 242, a researcher 8 analyzes 250 the start-up item 25 to determine 254 if the start-up item 25 is malware. If the start-up item 25 is not malware 252, the master file 110M is updated to include the start-up item 25 (e.g., the start-up item is added 270 to the whitelist) the master file 110M (e.g., a whitelist) is distributed 272 to the protected devices 12.

If the start-up item 25 is malware 252, the researcher creates 254 a repair script. The repair script includes entries for killing any process that is known to be running with this type of start-up item 25 (e.g., malware), entries to quarantine or delete any files created by this start-up item 25; editing the registry or restoring the registry from a backup copy when it is known that the registry is modified with this type of start-up item 25, etc.

The repair script is stored 256 at the server 500 for any future detection of this start-up item 25 and the repair script repair script is retrieved 244 and either transmitted 258 to the protected device 12 or a remote access is made to the protected device 12 and the repair script is used to repair the protected device 12. As an example, if it is known that a certain process is running with this type of start-up item 25 (e.g., malware), the process is killed by the repair script; if certain programs or scripts are included with this start-up item 25, those programs or scripts are quarantined or deleted by the repair script; if a registry entry is made to initialize the start-up item 25 at startup, the registry is cleaned or restored from a back-up copy by the repair script, etc.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for device security, the system comprising:
a protected device, the protected device having a processor and an operating system software running on the processor;
security software running on the protected device, the security software has local data for control of the security software; and
the security software periodically accessing a list of start-up items and for each start-up item in the list of start-up items, the security software determines when that start-up item is malware and when that start-up item is the malware, the security software initiates actions to disable that start-up item.

2. The system of claim 1, wherein the security software determines when that start-up item is the malware using a whitelist of approved start-up items stored in the local data and that start-up item is the malware when that start-up item is absent from the whitelist of the approved start-up items.

3. The system of claim 1, wherein the security software determines when that start-up item is the malware using a blacklist of banned start-up items stored in the local data and that start-up item is the malware when that start-up item is present in the blacklist of the banned start-up items.

4. The system of claim 1, wherein the actions to disable that start-up item comprise the security software removes a registry entry for that start-up item from an operating system file of the protected device.

5. The system of claim 1, wherein the actions to disable that start-up item comprise the security software removes a browser-add-on related to that start-up item from a browser of the protected device.

6. The system of claim 1, wherein the actions to disable that start-up item comprise the security software forwards data regarding that start-up item to a server for analysis by a researcher.

7. The system of claim 1, wherein when that startup item is a known malware, the actions to disable that start-up item comprise the security software runs a script to clean up the known malware.

8. A method for security running on a protected device that has a processor and an operating system running on the processor, the method comprising:
periodically retrieving a list of start-up items from the operating system; and
for each start-up item in the list of start-up items, determining when the each start-up item is malware using local data and when the each start-up item is the malware, taking action(s) to disable the each start-up item.

9. The method of claim 8, wherein the step of determining when the each start-up item is the malware comprises searching for the each item in a whitelist of approved start-up items stored in the local data and determining when the each start-up item is the malware when the each start-up item is absent from the whitelist of the approved start-up items.

10. The method of claim 8, wherein the step of determining when the each start-up item is the malware comprises searching for the each start-up item in a blacklist of banned start-up items stored in the local data and determining when the each start-up item is the malware when the each start-up item is present in the blacklist of the banned start-up items.

11. The method of claim 8, wherein the step of taking the action(s) to disable the each start-up item comprises removing a registry entry for the each start-up item from an operating system file of the protected device.

12. The method of claim 8, wherein when the each start-up item is a known malware, the action(s) to disable the each start-up item comprise running a script to clean up the known malware.

13. The method of claim 8, wherein the step of taking the action(s) to disable the each start-up item comprises removing a browser add-on related to the each start-up item from a browser of the protected device.

14. The method of claim 8, wherein the step of taking the action(s) to disable the each start-up item comprises comprise forwarding data regarding the each start-up item to a server and analyzing the data by a researcher.

15. A system for device security, the system comprising:
a protected device having a processor and an operating system executed by the processor; and
security software stored in non-transitory storage of the protected device; the security software having local data and the security software executed by the processor to periodically access a list of start-up items from the operating system and for each start-up item in the list of start-up items, the security software determines when that start-up item is malware using the local data and when that start-up item is the malware, the security software initiates actions to disable that start-up item.

16. The system of claim 15, wherein the security software determines when that start-up item is the malware using a whitelist of approved start-up items stored in the local data and that start-up item is the malware when that start-up item is absent from the whitelist of the approved start-up items.

17. The system of claim 15, wherein the security software determines when that start-up item is the malware using a blacklist of banned start-up items stored in the local data and that start-up item is the malware when that start-up item is present in the blacklist of the banned start-up items.

18. The system of claim 15, wherein the actions to disable that start-up item comprise the security software removes a registry entry for that start-up item from an operating system file of the operating system that is executed by the processor of the protected device.

19. The system of claim 15, wherein the actions to disable that start-up item comprise the security software removes a browser add-on related to that start-up item from a browser of the protected device.

20. The system of claim 15, wherein when that startup item is a known malware, the actions to disable that start-up item comprise the security software runs a script to clean up the known malware.
